(19) United States
(12) Patent Application Publication
(10) Pub. No.: US 2022/0250309 A1
(43) Pub. Date: Aug. 11, 2022

(54) METHODS OF FORMING THERMOPLASTIC PRINT BEADS INTO NET SHAPE STRUCTURES FOR USE IN ADDITIVE MANUFACTURING

(71) Applicant: General Electric Company, Schenectagy, NY (US)

(72) Inventors: James Robert Tobin, Greenville, SC (US); Andrew McCalip, Houston, TX (US); Collin McKee Sheppard, Greenville, SC (US); Jacob David Frady, Houston, TX (US)

(21) Appl. No.: 17/629,994

(22) PCT Filed: Jul. 26, 2019
(86) PCT No.: PCT/US2019/043693

§ 371 Date: Jan. 25, 2022

(51) Int. Cl. B29C 64/106; B29C 64/209; B29C 64/218; B29C 64/314; B29C 64/295; B29C 64/321; B33Y 10/00; B33Y 30/00; B33Y 40/10; B33Y 80/00

(52) U.S. Cl. CPC B29C 64/106; B29C 64/209; B29C 64/218; B29C 64/314; B29C 64/295; B29L 2031/085; B33Y 10/00; B33Y 30/00; B33Y 40/10; B33Y 80/00; B29C 64/321

(57) ABSTRACT

A method for forming an article includes placing at least one forming tool of the article adjacent to a substrate, the at least one forming tool having a predefined shape and/or height. The method also includes extruding a bead of material from a printer head of a print head assembly directly into or onto the forming tool(s) of the article so as to increase a height of the bead of material via the forming tool(s), thereby reducing or eliminating a number of extruded layers of the material. Further, the method includes allowing the material to solidify to form the article. Thus, by using the forming tool(s), multiple printed layers of the material can be eliminated or reduced.

### FIELD

The present disclosure relates in general to additive manufacturing, and more particularly to methods of forming continuous or bulk print beads into final or near net shape structures.

### BACKGROUND

Wind power is considered one of the cleanest, most environmentally friendly energy sources presently available, and wind turbines have gained increased attention in this regard. A modern wind turbine typically includes a tower, a generator, a gearbox, a nacelle, and one or more rotor blades. The rotor blades capture kinetic energy of wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The rotor blades generally include a suction side shell and a pressure side shell typically formed using molding processes that are bonded together at bond lines along the leading and trailing edges of the blade. Further, the pressure and suction shells are relatively lightweight and have structural properties (e.g., stiffness, buckling resistance and strength) which are not configured to withstand the bending moments and other loads exerted on the rotor blade during operation. Thus, to increase the stiffness, buckling resistance and strength of the rotor blade, the body shell is typically reinforced using one or more exterior structural components (e.g. opposing spar caps with a shear web configured therebetween) that engage the inner pressure and suction side surfaces of the shell halves.

The spar caps are typically constructed of various materials, including but not limited to glass fiber laminate composites and/or carbon fiber laminate composites. The shell of the rotor blade is generally built around the spar caps of the blade by stacking layers of fiber fabrics in a shell mold. The layers are then typically infused together with a resin.

With the increase in popularity of additive manufacturing, however, it would be desirable to manufacture some of the various wind turbine components using such techniques. Traditionally, plastic additive manufacturing processes use a single bead of material having a constant size to print layer by layer to form a final article having a three-dimensional (3-D) shape. Thus, an issue with traditional additive manufacturing processes is that building up the material can be time-consuming. Though larger bead sizes can be used in increase the build rate, this comes at a sacrifice of refinement and uses excess material.

In addition, typical extrusions are not directly made to bond to a substrate, as is often the case with additive manufacturing. Further, bonding between layers in fibrous materials becomes the weak point of the article.

In view of the foregoing, the present disclosure is directed to systems and methods of forming thermoplastic print beads into net shape structures for use in additive manufacturing processes, such as three-dimensional (3-D) printing.

### BRIEF DESCRIPTION

Aspects and advantages of the invention will be set forth in part in the following description, or may be obvious from the description, or may be learned through practice of the invention.

In one aspect, the present disclosure is directed to a method for forming an article. The method includes placing at least one forming tool of the article adjacent to a substrate, the at least one forming tool having a predefined shape and/or height. The method also includes extruding a bead of material from a printer head of a print head assembly directly into or onto the forming tool(s) of the article so as to increase a height of the bead of material via the forming tool(s), thereby reducing or eliminating a number of extruded layers of the material. Further, the method includes allowing the material to solidify to form the article. Thus, by using the forming tool(s), multiple printed layers of the material can be eliminated or reduced.

In an embodiment, the forming tool may include a die, a mold, or a rolling element. For example, in one embodiment, the forming tool may include the rolling element. As such, in an embodiment, the method may include securing the rolling element to the printer head of the print head assembly, extruding the bead of material from the printer head ahead of or directly into a cavity defined by a cross-sectional shape of the rolling element, and rolling the rolling element along the substrate such that the height of the bead of the material is increased so as to form the article on the substrate.

In further embodiments, the method may include moving the forming tool(s) along the substrate at a predetermined speed as the bead of material is being deposited therein. Thus, the predetermined speed and a length of the forming tool(s) may be selected to ensure the bead of material has sufficiently solidified before the bead of material exits the forming tool(s).

In another embodiment, at least a portion of the forming tool(s) may be deformable so as to conform to a profile of the substrate as the forming tool(s) is moved along the substrate. Further, in an embodiment, the method may include moving the forming tool(s) directly on the substrate.

In additional embodiments, at least a portion of the forming tool(s) may be rigid. In such embodiments, the method may include holding the forming tool(s) above and spaced apart from the substrate via a gap as the forming tool(s) is moved along the substrate, wherein the gap allows for squeeze out of the material to increase a bond area between the at least one forming tool and the substrate.

In several embodiments, the method may include securing the forming tool(s) behind the printer head. Alternatively, the method may include securing the printer head at a center of the forming tool(s).

In particular embodiments, the forming tool(s) may be the mold. In such embodiments, the method may include extruding the bead of material from the printer head directly into the mold and pressing the mold onto the substrate so as to form the article. In addition, the mold may have at least one deformable surface.

Thus, in an embodiment, the method may include pressing the mold onto the substrate so before the bead of material is extruded into the mold of the article and extruding, via the printer head, the bead of material into an inlet of the mold while the mold is pressed to the substrate. In another embodiment, the method may include holding the mold pressed to the substrate until the bead of material solidifies and bonds to the substrate.

In another embodiment, the method may include heating the forming tool(s) to control a melt rate of the material.

In an embodiment, the method may include cooling the forming tool(s) so as to partially cool the material deposited therein such that the material holds its shape.

In yet another embodiment, the material may include a thermoplastic material, a thermoset material, a metal material, or a concrete material. In addition, in an embodiment, the article may include a rotor blade component of a wind turbine.

In another aspect, the present disclosure is directed to a system for forming an article. The system includes a substrate and a print head assembly having a printer head mounted above the substrate. The printer head is configured for extruding a bead of material. The system also includes at least one forming tool for forming the bead of material to a predefined shape and/or height of the article as the bead of material is being extruded so as to increase a height of the bead of material via the forming tool(s), thereby reducing or eliminating a number of extruded layers of the material.

In yet another aspect, the present disclosure is directed to a method for forming a plurality of articles. The method includes (a) providing a forming tool of one of the plurality of articles having a predefined shape and/or height. The method also includes (b) extruding a bead of material from a print head assembly and into the forming tool. Further, the method includes (c) allowing the material to at least partially solidify in the forming tool so as to hold its shape and to form one of the plurality of articles. Moreover, the method includes (d) moving the forming tool along the substrate as the article is released from the forming tool. In addition, the method includes (e) repeating steps (a) through (d) to form the plurality of articles. Thus, the method includes (f) providing a deformable component at an intersection point between the plurality of articles. Further, the method includes (g) heating the deformable component at the intersection point so as to melt the material at the intersection point. Accordingly, the method includes (h) adding additional material at the intersection point so as to join the plurality of articles. It should be understood that the method may further include any of the additional steps and/or features described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a perspective view of one embodiment of a rotor blade of a wind turbine according to the present disclosure;

FIG. 3 illustrates an exploded view of the modular rotor blade of FIG. 2;

FIG. 4 illustrates a cross-sectional view of one embodiment of a leading edge segment of a modular rotor blade according to the present disclosure;

FIG. 5 illustrates a cross-sectional view of one embodiment of a trailing edge segment of a modular rotor blade according to the present disclosure;

FIG. 6 illustrates a cross-sectional view of the modular rotor blade of FIG. 2 according to the present disclosure;

FIG. 7 illustrates a cross-sectional view of the modular rotor blade of FIG. 2 according to the present disclosure;

FIG. 8A illustrates a perspective view of one embodiment of a system for forming an article according to the present disclosure, particularly illustrating a forming tool secured to a printer head of the system;

FIG. 8B illustrates a detailed, front view of the forming tool of the system of FIG. 8A;

FIG. 8C illustrates a detailed, perspective view of the forming tool of the system of FIG. 8A, particularly illustrating the forming tool being rolled along a substrate so as to form a grid structure;

FIG. 8D illustrates a detailed, cross-sectional view of the forming tool of the system of FIG. 8A;

FIG. 9A illustrates a front, perspective view of one embodiment of a plurality of forming tools of a system for forming an article according to the present disclosure;

FIG. 9B illustrates a bottom, perspective view of the plurality of forming tools of FIG. 9A;

FIG. 10 illustrates a perspective view of another embodiment of a forming tool of a system for forming an article according to the present disclosure;

FIG. 11 illustrates a perspective view of another embodiment of a mold of a system for forming a grid structure according to the present disclosure, particularly illustrating the mold and the grid structure positioned atop a substrate;

FIG. 12 illustrates a detailed, perspective view of a portion of the mold of FIG. 11;

FIG. 13 illustrates a flow diagram of one embodiment of a method of forming an article according to the present disclosure;

FIG. 14 illustrates a schematic diagram of one embodiment of a system for forming an article according to the present disclosure, particularly illustrating a forming tool of the system spaced apart from a curved substrate such that the forming tool can move along the surface during printing; and

FIG. 15 illustrates a flow diagram of one embodiment of a method of forming and joining a plurality of articles according to the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to systems and methods for printing material in a continuous or bulk process leading to a final or near-shaped part or structure. More specifically, the systems and methods of the present disclosure allow extruded material to be laid down in well-defined shapes due to forming the bead of printed material to a defined contour and height. Typical 3-D printing is generally understood to encompass processes used to synthesize three-dimensional objects in which successive layers of material are formed under computer control to create the objects. However, the bond between the layers may be a weak point of the part due to a lack of fibers between the two. Therefore, by forming the continuous or bulk bead of material, the present disclosure allows the extruded material to be laid down in well-defined shapes due to forming the bead to a taller and narrower profile. This process eliminates or reduces the need for multiple layers of printing, thereby increasing the vertical build rate without using additional material to build the bead wider. The present disclosure also allows for extrusions to be printed in a continuous fashion of any length and for the direction of travel to change as the print occurs. Further, the systems and methods of the present disclosure are able to follow a 3-D contoured mold or substrate.

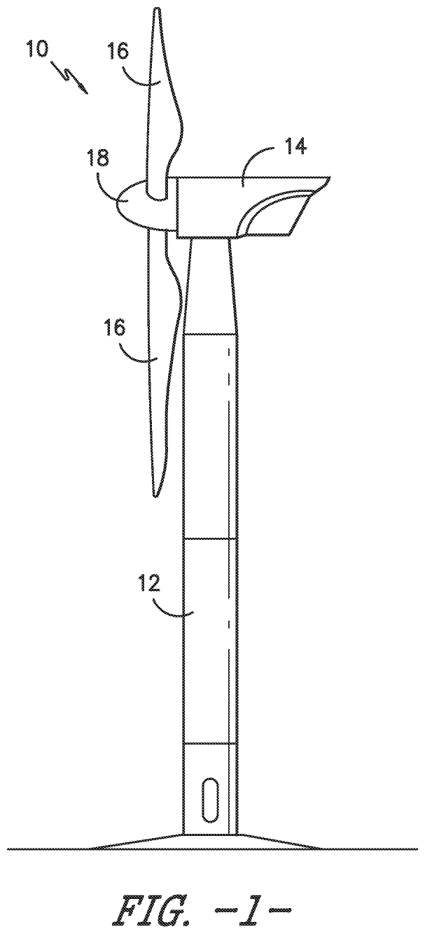

Referring now to the drawings, FIG. 1 illustrates one embodiment of a wind turbine 10 according to the present disclosure. As shown, the wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration. In addition, the present invention is not limited to use with wind turbines, but may be utilized in any application using resin materials. Further, the methods described herein may also apply to manufacturing any similar structure that benefits from the resin formulations described herein.

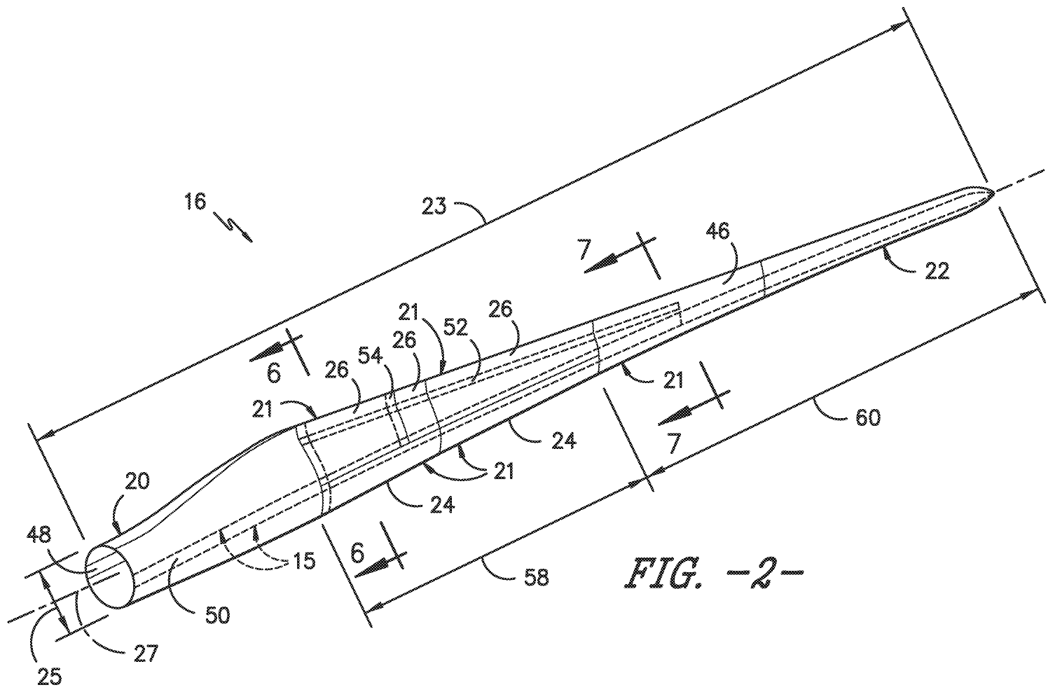

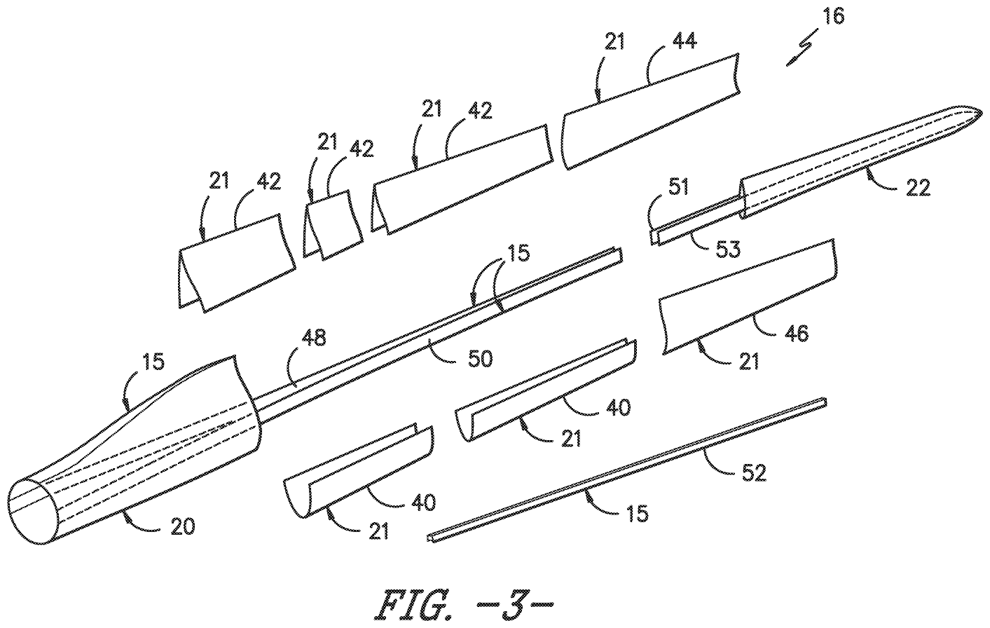

Referring now to FIGS. 2 and 3, various views of a rotor blade 16 according to the present disclosure are illustrated. As shown, the illustrated rotor blade 16 has a segmented or modular configuration. It should also be understood that the rotor blade 16 may include any other suitable configuration now known or later developed in the art. As shown, the modular rotor blade 16 includes a main blade structure 15 and at least one blade segment 21 secured to the main blade structure 15. More specifically, as shown, the rotor blade 16 includes a plurality of blade segments 21.

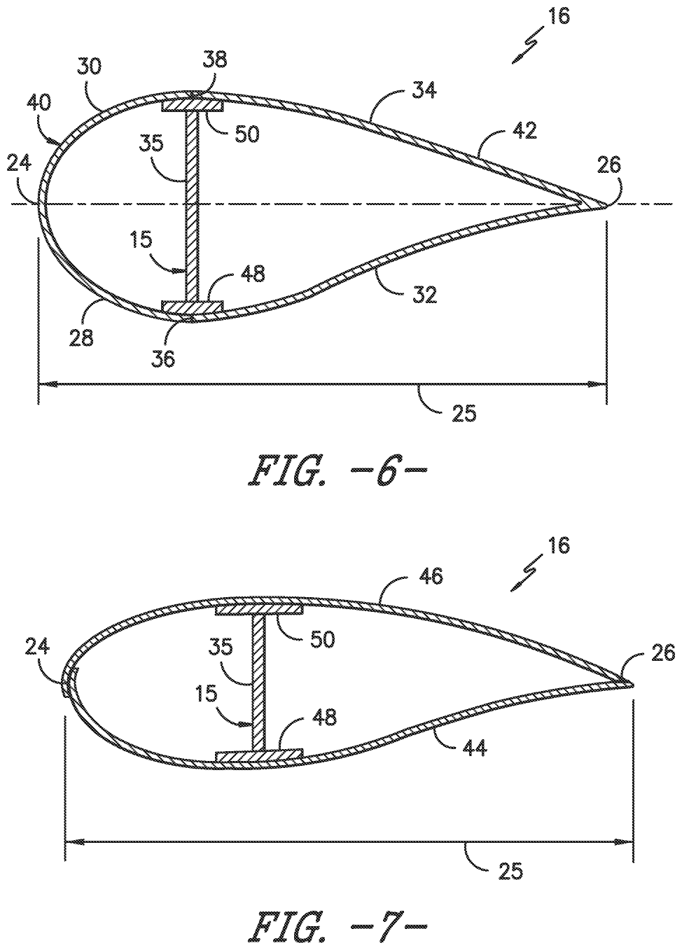

More specifically, as shown, the main blade structure 15 may include any one of or a combination of the following: a pre-formed blade root section 20, a pre-formed blade tip section 22, one or more one or more continuous spar caps 48, 50, 51, 53, one or more shear webs 35 (FIGS. 6-7), an additional structural component 52 secured to the blade root section 20, and/or any other suitable structural component of the rotor blade 16. Further, the blade root section 20 is configured to be mounted or otherwise secured to the rotor 18 (FIG. 1). In addition, as shown in FIG. 2, the rotor blade 16 defines a span 23 that is equal to the total length between the blade root section 20 and the blade tip section 22. As shown in FIGS. 2 and 6, the rotor blade 16 also defines a chord 25 that is equal to the total length between a leading edge 24 of the rotor blade 16 and a trailing edge 26 of the rotor blade 16. As is generally understood, the chord 25 may generally vary in length with respect to the span 23 as the rotor blade 16 extends from the blade root section 20 to the blade tip section 22.

Referring particularly to FIGS. 2-4, any number of blade segments 21 or panels (also referred to herein as blade shells) having any suitable size and/or shape may be generally arranged between the blade root section 20 and the blade tip section 22 along a longitudinal axis 27 in a generally span-wise direction. Thus, the blade segments 21 generally serve as the outer casing/covering of the rotor blade 16 and may define a substantially aerodynamic profile, such as by defining a symmetrical or cambered airfoil-shaped cross-section.

In additional embodiments, it should be understood that the blade segment portion of the blade 16 may include any combination of the segments described herein and are not limited to the embodiment as depicted. More specifically, in certain embodiments, the blade segments 21 may include any one of or combination of the following: pressure and/or suction side segments 44, 46, (FIGS. 2 and 3), leading and/or trailing edge segments 40, 42 (FIGS. 2-6), a non-jointed segment, a single-jointed segment, a multi jointed blade segment, a J-shaped blade segment, or similar.

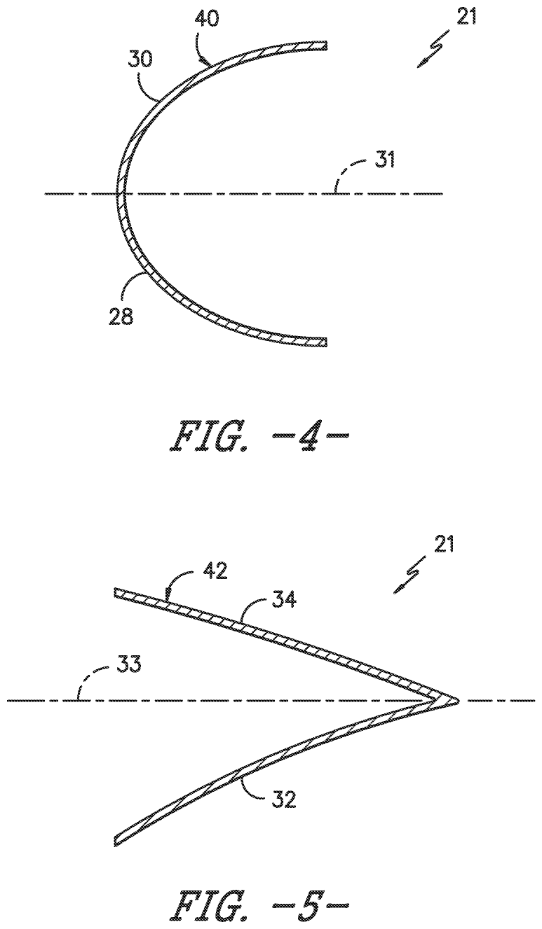

More specifically, as shown in FIG. 4, the leading edge segments 40 may have a forward pressure side surface 28 and a forward suction side surface 30. Similarly, as shown in FIG. 5, each of the trailing edge segments 42 may have an aft pressure side surface 32 and an aft suction side surface 34. Thus, the forward pressure side surface 28 of the leading edge segment 40 and the aft pressure side surface 32 of the trailing edge segment 42 generally define a pressure side surface of the rotor blade 16. Similarly, the forward suction side surface 30 of the leading edge segment 40 and the aft suction side surface 34 of the trailing edge segment 42 generally define a suction side surface of the rotor blade 16. In addition, as particularly shown in FIG. 6, the leading edge segment(s) 40 and the trailing edge segment(s) 42 may be joined at a pressure side seam 36 and a suction side seam 38. For example, the blade segments 40, 42 may be configured to overlap at the pressure side seam 36 and/or the suction side seam 38. Further, as shown in FIG. 2, adjacent blade segments 21 may be configured to overlap at a seam 54. Alternatively, in certain embodiments, the various segments of the rotor blade 16 may be secured together via an adhesive (or mechanical fasteners) configured between the overlapping leading and trailing edge segments 40, 42 and/or the overlapping adjacent leading or trailing edge segments 40, 42.

In specific embodiments, as shown in FIGS. 2-3 and 6-7, the blade root section 20 may include one or more longitudinally extending spar caps 48, 50 infused therewith. For example, the blade root section 20 may be configured according to U.S. application Ser. No. 14/753,155 filed Jun. 29, 2015 entitled “Blade Root Section for a Modular Rotor Blade and Method of Manufacturing Same” which is incorporated herein by reference in its entirety.

Similarly, the blade tip section 22 may include one or more longitudinally extending spar caps 51, 53 infused therewith. More specifically, as shown, the spar caps 48, 50, 51, 53 may be configured to be engaged against opposing inner surfaces of the blade segments 21 of the rotor blade 16. Further, the blade root spar caps 48, 50 may be configured to align with the blade tip spar caps 51, 53. Thus, the spar caps 48, 50, 51, 53 may generally be designed to control the bending stresses and/or other loads acting on the rotor blade 16 in a generally span-wise direction (a direction parallel to the span 23 of the rotor blade 16) during operation of a wind turbine 10. In addition, the spar caps 48, 50, 51, 53 may be designed to withstand the span-wise compression occurring during operation of the wind turbine 10. Further, the spar cap(s) 48, 50, 51, 53 may be configured to extend from the blade root section 20 to the blade tip section 22 or a portion thereof. Thus, in certain embodiments, the blade root section 20 and the blade tip section 22 may be joined together via their respective spar caps 48, 50, 51, 53.

Referring to FIGS. 6-7, one or more shear webs 35 may be configured between the one or more spar caps 48, 50, 51, 53. More particularly, the shear web(s) 35 may be configured to increase the rigidity in the blade root section 20 and/or the blade tip section 22. Further, the shear web(s) 35 may be configured to close out the blade root section 20.

In addition, as shown in FIGS. 2 and 3, the additional structural component 52 may be secured to the blade root section 20 and extend in a generally span-wise direction so as to provide further support to the rotor blade 16. For example, the structural component 52 may be configured according to U.S. application Ser. No. 14/753,150 filed Jun. 2, 2015 entitled “Structural Component for a Modular Rotor Blade” which is incorporated herein by reference in its entirety. More specifically, the structural component 52 may extend any suitable distance between the blade root section 20 and the blade tip section 22. Thus, the structural component 52 is configured to provide additional structural support for the rotor blade 16 as well as an optional mounting structure for the various blade segments 21 as described herein. For example, in certain embodiments, the structural component 52 may be secured to the blade root section 20 and may extend a predetermined span-wise distance such that the leading and/or trailing edge segments 40, 42 can be mounted thereto.

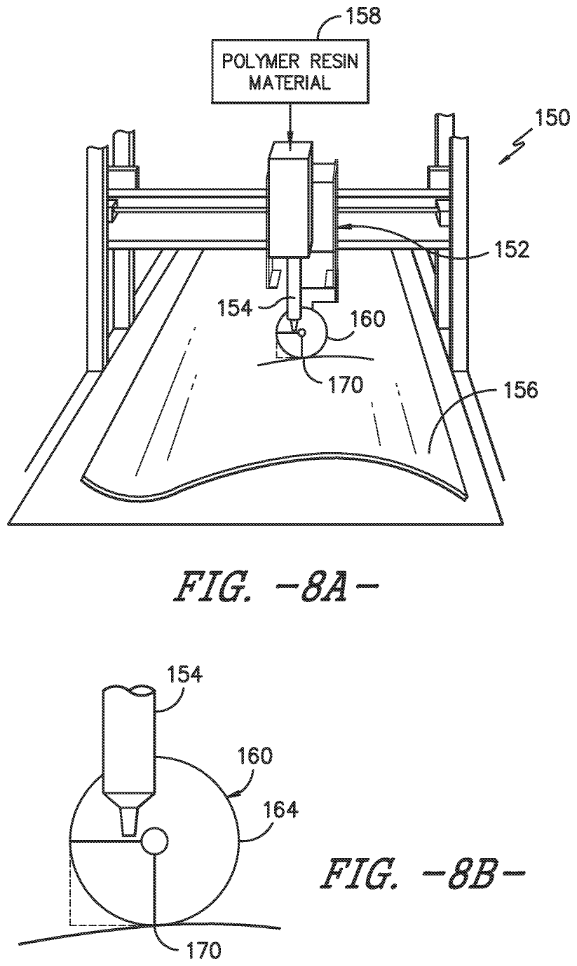

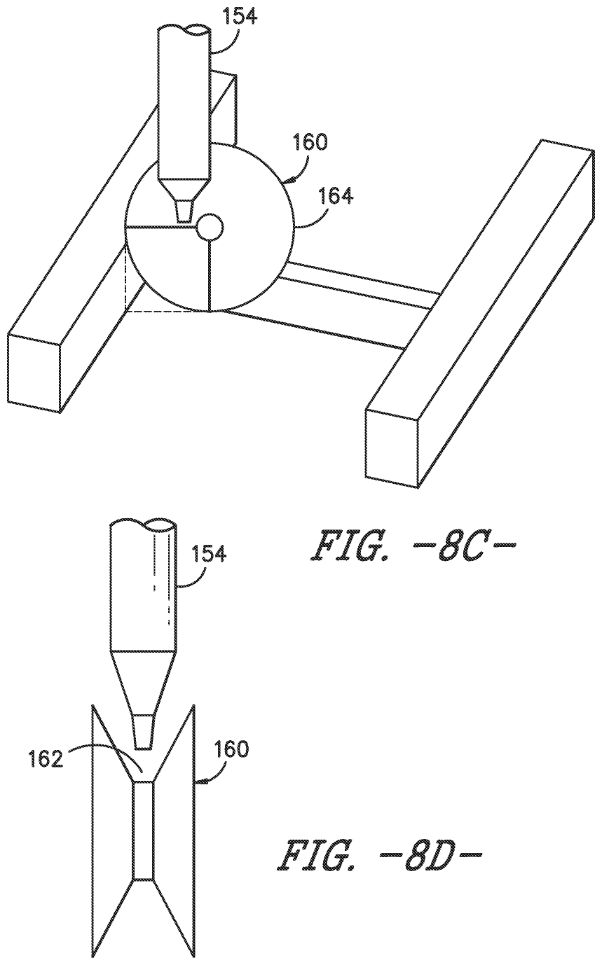

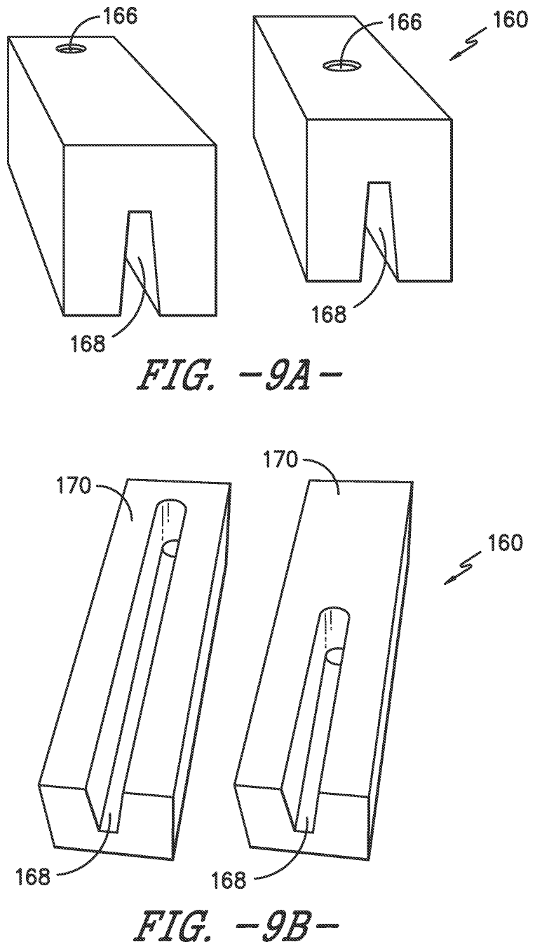

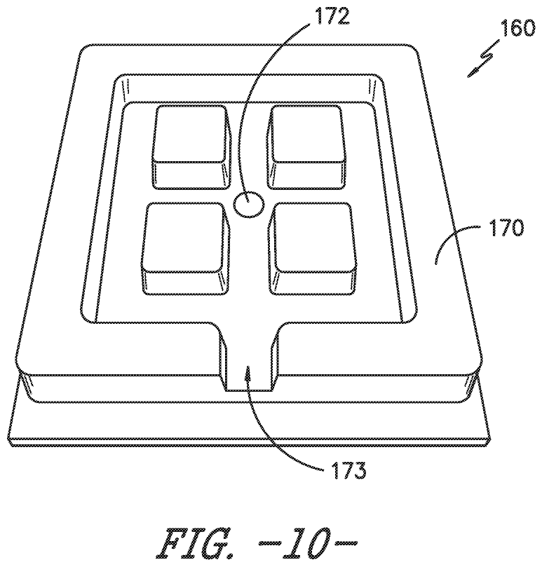

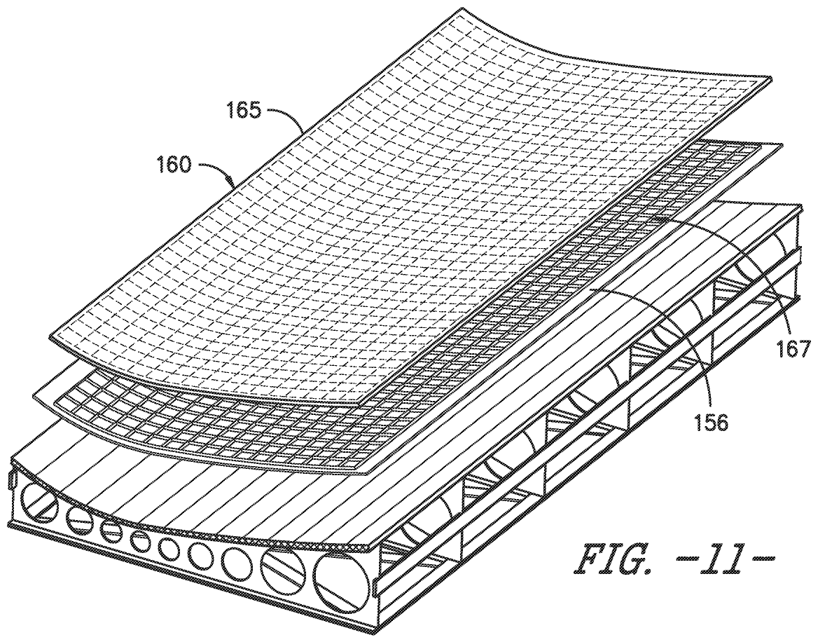

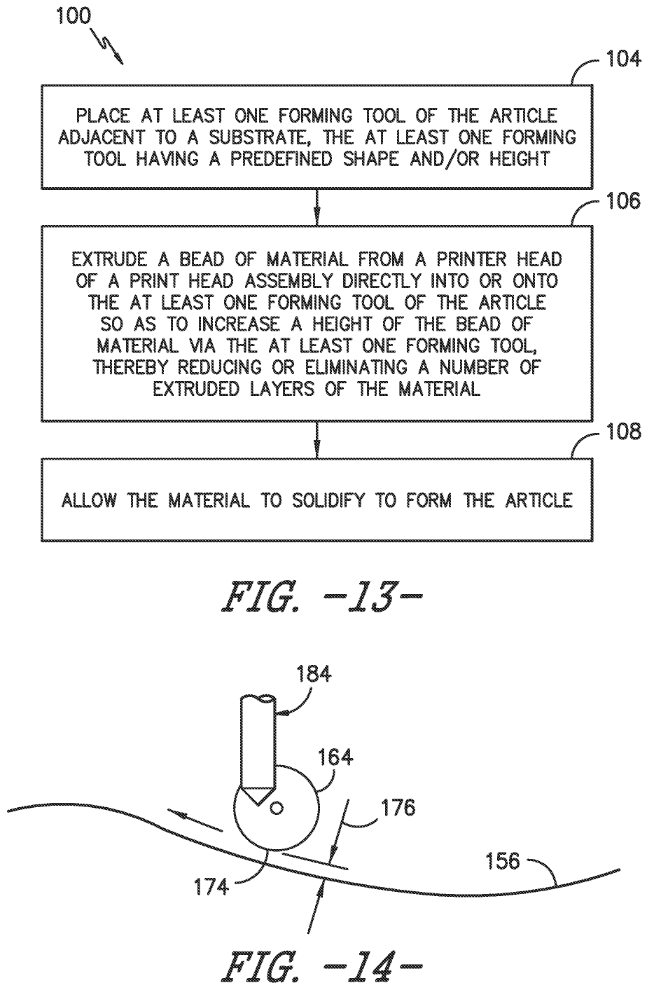

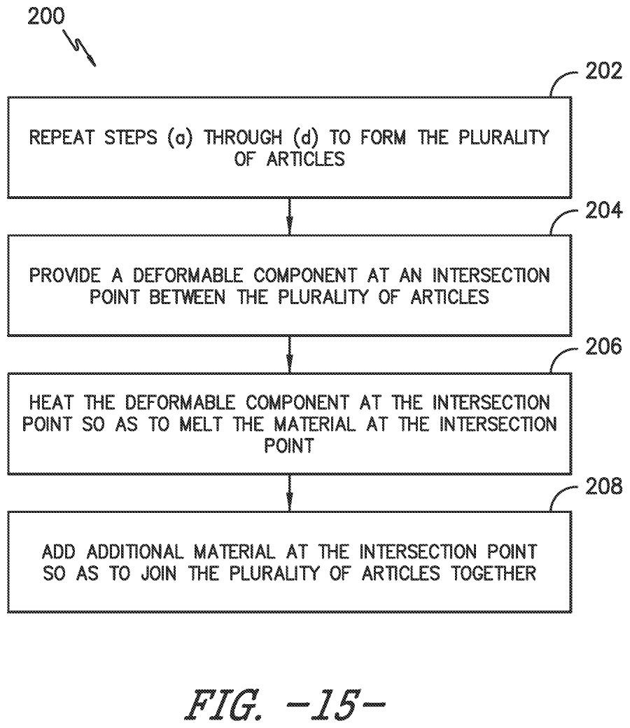

Referring now to FIGS. 8-15, the present disclosure is directed to systems and methods for forming polymer articles, such as any of the rotor blade components described herein. More specifically, FIGS. 8A-8D illustrate perspective views of one embodiment of a system 150 for forming an article according to the present disclosure. FIGS. 9A-9B illustrate various views of one embodiment of a forming tool 160 of the system 150 according to the present disclosure. FIGS. 10-12 illustrate various views of another embodiment of a forming tool 160 of the system 150 according to the present disclosure, particularly illustrating a forming tool that is a mold. FIG. 14 illustrates a side view of yet another embodiment of a forming tool 160 of the system 150 according to the present disclosure, particularly illustrating a forming tool 160 that is a rolling element 164. FIGS. 13 and 15 illustrate flow diagrams of various embodiments of methods for forming an article according to the present disclosure. As such, in certain embodiments, the article may include a rotor blade shell (a pressure side shell, a suction side shell, a trailing edge segment, a leading edge segment, etc.), a spar cap, a shear web, a blade tip, a blade root, or any other rotor blade component.

For example, as shown in FIG. 8A, a perspective view of one embodiment the system 150 including a computer numeric control (CNC) device 152 according to the present disclosure is illustrated. More specifically, as shown, the print head assembly 152 may include one or more extruders 154 or printer heads that can be designed having any suitable thickness or width so as to disperse a desired amount of a material 158, such as thermoplastic material, a thermoset material, a metal material, a concrete material, etc., to create the articles described herein with varying sizes, heights, and/or thicknesses. Further, as shown, the print head assembly 152 typically includes a substrate 156 where the desired article can be printed. For example, in the illustrated embodiment, the substrate 156 may be a curved surface, e.g. corresponding to a contour of the rotor blade 16.

The thermoplastic materials described herein generally encompass a plastic material or polymer that is reversible in nature. For example, thermoplastic materials typically become pliable or moldable when heated to a certain temperature and returns to a more rigid state upon cooling. Further, thermoplastic materials may include amorphous thermoplastic materials and/or semi-crystalline thermoplastic materials. For example, some amorphous thermoplastic materials may generally include, but are not limited to, styrenes, vinyls, cellulosics, polyesters, acrylics, polysulphones, and/or imides. More specifically, exemplary amorphous thermoplastic materials may include polystyrene, acrylonitrile butadiene styrene (ABS), polymethyl methacrylate (PMMA), glycolised polyethylene terephthalate (PET-G), polycarbonate, polyvinyl acetate, amorphous polyamide, polyvinyl chlorides (PVC), polyvinylidene chloride, polyurethane, or any other suitable amorphous thermoplastic material. In addition, exemplary semi-crystalline thermoplastic materials may generally include, but are not limited to polyolefins, polyamides, fluropolymer, ethyl-methyl acrylate, polyesters, polycarbonates, and/or acetals. More specifically, exemplary semi-crystalline thermoplastic materials may include polybutylene terephthalate (PBT), polyethylene terephthalate (PET), polypropylene, polyphenyl sulfide, polyethylene, polyamide (nylon), polyetherketone, or any other suitable semi-crystalline thermoplastic material. For example, in one embodiment, a semi-crystalline thermoplastic resin that is modified to have a slow rate of crystallization may be used. In addition, blends of amorphous and semi-crystalline polymers may also be used.

The thermoset materials as described herein generally encompass a plastic material or polymer that is non-reversible in nature. For example, thermoset materials, once cured, cannot be easily remolded or returned to a liquid state. As such, after initial forming, thermoset materials are generally resistant to heat, corrosion, and/or creep. Example thermoset materials may generally include, but are not limited to, some polyesters, some polyurethanes, esters, epoxies, or any other suitable thermoset material.

In addition, as mentioned, the thermoplastic and/or the thermoset materials as described herein may optionally be reinforced with a fiber material, including but not limited to glass fibers, carbon fibers, polymer fibers, wood fibers, bamboo fibers, ceramic fibers, nanofibers, metal fibers, or similar or combinations thereof. In addition, the direction of the fibers may include multi-axial, unidirectional, biaxial, triaxial, or any other another suitable direction and/or combinations thereof. Further, the fiber content may vary depending on the stiffness required in the corresponding blade component, the region or location of the blade component in the rotor blade 16, and/or the desired weldability of the component.

Referring back to FIGS. 8A-8D, the system 150 also includes at least one forming tool 160 for forming the article. For example, as shown, the forming tool 160 may have a defined shape and/or height corresponding to a shape of the article to be formed. As such, in an embodiment, the printer head 154 is configured for extruding a bead of the material 158 into or onto the forming tool 160 so as to shape the bead of material via the forming tool 160, thereby reducing or eliminating a number of extruded layers of the material.

In certain embodiments, the forming tool 160 may be a die, a mold, or a rolling element. More specifically, as shown particularly in FIGS. 8A-8D, the forming tool 160 may be secured to and/or adjacent to the printer head 154 of the print head assembly 152. For example, as shown in FIGS. 8A, 8B, and 8C, the rolling element 164 may be secured behind the printer head 154. Alternatively, as shown in FIG. 8D, the printer head 154 may be secured at a center of the rolling element 164 such that the material 158 can be directly printed into the cavity 162 (or into one or more openings 166 in the forming tool 160, see e.g. FIGS. 9A and 9B).

As shown particularly in FIGS. 9A and 9B, the forming tool 160 may also be a mold having a vertical wall or thin inverted V-shape 168. Accordingly, the printer head 154 is configured to compact the melted material 158 into the forming tool 160 to form a net shape cross section. This process can be done in a continuous manner to print the cross section in any length and in straight or curved paths.

In such embodiments, where the forming tool 160 is attached to the printer head 154, the forming tool 160 and/or the printer head 154 may also be configured to rotate during printing so as to facilitate printing of the articles described herein in multiple directions. Accordingly, the forming tool 160 and/or the printer head 154 can be rotatable about an axis and controlled to position the forming tool 160 and/or the printer head 154 relative to the direction of travel.

In addition, as will be described in more detail herein, the forming tool 160 may also have at least one deformable surface 170 that conforms to a contoured substrate, e.g. the substrate 156. In addition, as shown in FIG. 14, and as will be explained in more detail herein, the forming tool 160 may also have at least one rigid surface 174.

For example, as shown in FIGS. 8A-8D, the forming tool 160 may include a rolling element 164 with a cavity 162 having a cross-sectional shape of the desired article. Further, as shown, the rolling element 164 may be secured to the printer head of the print head assembly 152. As such, in an embodiment, as shown in FIG. 8D, the material 158 may be extruded into the cavity 162 of the rolling element 164 and compressed therein as the material 158 is being extruded. Thus, as shown in FIG. 8C, the rolling element 164 can then be moved along the substrate such that the compressed bead of the material 158 is transferred from the cavity 162 to the substrate 156 so as to form the article (e.g. a grid structure) on the substrate 156.

Referring now to FIGS. 10-12, wherein the forming tool 160 is a die or mold 165, the shape of the article may also be molded with the forming tool 160 described herein. In such embodiments, as shown particularly in FIG. 10, the shape may be square, “plus” shaped, linear, or any other 2-D profile. Thus, as shown, material can be injected into the forming tool 160 via an inlet 172 and held until the material 158 solidifies enough to maintain the shape. The forming tool 160 may also include one or more outlets 173 to allow for squeeze out of the injected material. This process is configured to create shapes having any desired cross-section that is also bonded to the support surface (e.g. the blade skin) and that can be built up to the desired height in a single operation. This process can also be repeated using the same or different mold/mold shapes to create a continuous material. In certain instances, the dies/molds described herein may also have a deformable surface 170 that can conform to various curvatures, such as the curvature of the substrate 156 that also creates a seal for the material to be forced into.

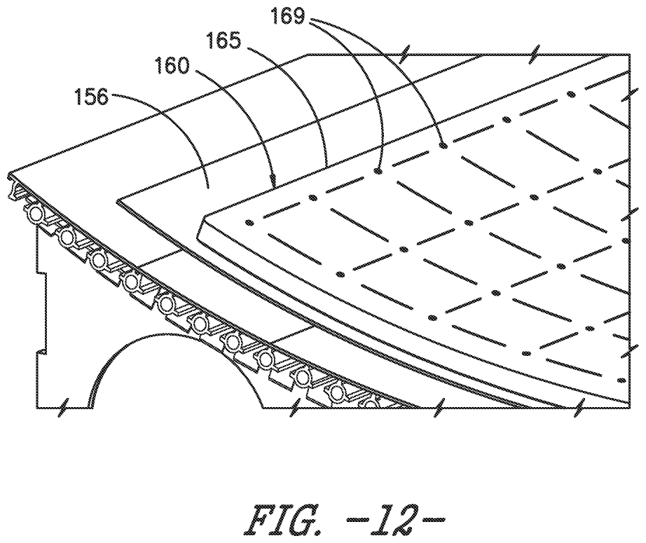

Referring particularly to FIGS. 11 and 12, rather than being attached to the printer head 154 of the print head assembly 152, the mold 165 may be detached from the printer head 154 and sized to correspond to the shape of the overall article. For example, as shown, the illustrated mold 165 corresponds to the shape of a grid structure 167 that is printed onto the substrate 156. In such embodiments, a bead of material may be printed in one pass or just a few passes, thereby eliminating or reducing layers in the grid structure 167. In such embodiments, the mold 165 may be one piece or segmented. As such, when segmented, the segments of the mold 165 can be made to interlock or abut against each other to form the mold 165.

More specifically, as still referring to FIGS. 11 and 12, the mold 165 may contain the female shape of the article to be formed, such as the grid structure 167. In addition, the mold 165 can be manufactured to fit the 3D curvature of the surface of the substrate 156. Alternatively, the mold 165 can be manufactured into a flat sheet of material and that can conform to the desired shape when placed onto the substrate 156.

In addition, as shown particularly in FIG. 12, the mold 165 may also contain one or more open slots 169 directly above at least a portion of the female openings in the mold 165 that define the shape of the article. Further, where the article is the grid structure 167, the grid spacing may be designed to match with the head to head spacing of the printer head 154 from a span-wise point of view. Accordingly, to make the grid structure 167, the printer head 154 moves over one end of an open slot and deposits material along the entire opening to fill the cavity in that area in preferably one shot (although a minimal number of passes could be used if desired).

At the end of a slot, the dispensing stops and the printer head 154 moves to the beginning of the next slot and dispenses again. The discontinuity between slots can enable the mold 165 to be made in larger pieces rather than having to place and temporarily bond a multitude of blocks to accomplish the same goal. This method not only eliminates layers which can improve grid material properties but also improves quality in the grid intersections. It should also be noted that while slots can be used, other openings are also possible such as individual holes where the printer head 154 deposit material into the hole openings, dispense material, stop, move to the next hole, and repeat. However, the use of slots may reduce the number of dispense starts and stops and reduce the amount of pressure on the melt to fill the desired shape.

It should be noted that due to the selected grid pattern, materials being printed, and the thermal conductivity of the mold 165, it may not be desirable to deposit all of the grid material in one pass. One example is that depositing too much material at one time may cause undesirable shrinkage bubbles to form upon cooling in the grid structure 167. That said, the presence of the mold 165 allows the printer head 154 to deposit more material typically sooner than would otherwise be possible with an unsupported printed structure. In an unsupported printed structure, depositing more molten material before the just-printed bead of material is allowed to cool can result in sagging, or pooling of the just-printed bead of material. With the mold 165 present to support both the just-printed bead of material and the newly-deposited material, better bonding can be achieved. Still referring to FIGS. 11 and 12, another feature of the mold 165 may include one or more draft angles to allow for easy removal of the mold 165 after the grid structure 167is solidified.

Referring now to FIG. 13, the method 100 is described herein as implemented for manufacturing the rotor blade components described above. However, it should be appreciated that the disclosed method 100 may be used to manufacture any other rotor blade components as well as any other articles. In addition, although FIG. 13 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (102), the method 100 includes placing at least one forming tool 160 of the article adjacent to a substrate 156. As such, the forming tool 160 has a predefined shape and/or height. As shown at (104), the method 100 includes extruding a bead of material 158 from the printer head 154 of the print head assembly 152 directly into or onto the forming tool 160 of the article so as to increase a height of the bead of material 158 via the forming tool 160. As such, the number of extruded layers of the material can be reduced and/or eliminated. As shown at (106), the method 100 includes allowing the material 158 to solidify on the substrate 156 to form the article.

In an embodiment, as mentioned, the forming tool 160 may include the rolling element 164. As such, the method 100 may include securing the rolling element 162 to the printer head 154, extruding the material 158 from the printer head 154 directly into the cavity 162 defined by a cross-sectional shape of the rolling element 164 such that the material 158 is compressed in the cavity 162, and rolling the rolling element 164 along the substrate 156 such that the compressed material 158 is transferred from the cavity 152 to the substrate 156 so as to form the article on the substrate 156.

In further embodiments, the method 100 may include moving the forming tool 160 along the substrate 156 at a predetermined speed as the material 158 is being deposited therein. Thus, the predetermined speed and a length of the forming tool 160 may be selected to ensure the material 158 has sufficiently solidified before exiting the forming tool 160. In an embodiment, at least a portion of the forming tool 160 may be deformable (e.g. via deformable surface 170) so as to conform to a curved profile of the substrate 156 as the forming tool 160 is moved along the substrate 156. Thus, the forming tool 160 can be moved directly across the substrate 156.

In additional embodiments, at least a portion of the forming tool 160 may be rigid (e.g. may have at least one rigid surface 174). In such embodiments, as shown in FIG. 14, the method 100 may include holding the forming tool 160 above and spaced apart from the substrate via a gap 176 as the forming tool 160 is moved along the substrate 156. Thus, the gap 176 allows for squeeze out of the material to increase a bond area between the forming tool 160 and the substrate 156. As such, the compression of the material 158 from the sides and top of the forming tool 160 improves its properties and bonding. Further, the present disclosure allows for an extrusion to be printed in a continuous fashion of any length and for the direction of travel to change as the print occurs.

In other embodiments, as mentioned, the forming tool 160 may be the mold (FIGS. 10-12). In such embodiments, the method 100 may include extruding the bead of material 158 from the printer head 154 directly into the mold and pressing the mold onto the substrate 156 so as to form the article. In addition, the mold may have at least one deformable surface that conforms to the substrate 156.

Thus, in an embodiment, the method 100 may include pressing the mold onto the substrate 156 so before the bead of material 158 is extruded into the mold of the article and extruding, via the printer head 154, the bead of material 158 into an inlet 172 of the mold while the mold is pressed to the substrate 156. In another embodiment, the method 100 may include holding the mold pressed to the substrate 156 until the bead of material 158 solidifies and bonds to the substrate 156.

In another embodiment, the method 100 may include heating the forming tool 160 to control a melt rate of the material 158. In addition, in an embodiment, allowing the material 158 to solidify to form the article may include cooling the forming tool 160 to cool the material 158 deposited therein.

Referring now to FIG. 15, a flow diagram of one embodiment of a method 200 for forming a plurality of articles according to the present disclosure is illustrated. The method 200 is described herein as implemented for manufacturing the rotor blade components described above. However, it should be appreciated that the disclosed method 200 may be used to manufacture any other rotor blade components as well as any other articles. In addition, although FIG. 15 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 may include repeating the same process for forming a single article as set forth in FIG. 13, including each of steps (102) though (106), for forming a plurality of articles. For example, the articles can then be joined together using the flow diagram of FIG. 15. More specifically, continuing at (204), the method 200 includes providing a deformable component at an intersection point between the plurality of articles. As shown at (206), the method 200 includes heating the deformable component at the intersection point so as to melt the material at the intersection point. As shown at (208), the method 200 adding additional polymer resin material at the intersection point so as to join the plurality of articles. Accordingly, the deformable component deforms around or is shaped to leave an opening for intersecting material paths. This deformable material can then be pressed over an intersection point, heated to melt the previously-solidified material, and additional material can be injected.

Various aspects and embodiments of the present invention are defined by the following numbered clauses:

Clause 1. A method for forming an article, comprising:

placing at least one forming tool of the article adjacent to a substrate, the at least one forming tool having a predefined shape and/or height;

extruding a bead of material from a printer head of a print head assembly directly into or onto the at least one forming tool of the article so as to increase a height of the bead of material via the at least one forming tool, thereby reducing or eliminating a number of extruded layers of the material; and,

allowing the material to solidify to form the article.

Clause 2. The method of Clause 1, wherein the at least one forming tool comprises a die, a mold, or a rolling element.

Clause 3. The method of Clause 2, wherein the at least one forming tool comprises the rolling element, the method further comprising:

securing the rolling element to the printer head of the print head assembly;

extruding the bead of material from the printer head ahead of or directly into a cavity defined by a cross-sectional shape of the rolling element; and

rolling the rolling element along the substrate such that the height of the bead of the material is increased so as to form the article on the substrate.

Clause 4. The method of any of the preceding clauses, further comprising moving the at least one forming tool along the substrate at a predetermined speed as the bead of material is being deposited therein, the predetermined speed and a length of the at least one forming tool being selected to ensure the bead of material has sufficiently solidified before the bead of material exits the at least one forming tool.

Clause 5. The method of Clause 4, wherein at least a portion of the at least one forming tool is deformable so as to conform to a profile of the substrate as the at least one forming tool is moved along the substrate, the method further comprising moving the at least one forming tool directly on the substrate.

Clause 6. The method of any of the preceding clauses, wherein at least a portion of the at least one forming tool is rigid, the method further comprising holding the at least one forming tool above and spaced apart from the substrate via a gap as the at least one forming tool is moved along the substrate, wherein the gap allows for squeeze out of the material to increase a bond area between the at least one forming tool and the substrate.

Clause 7. The method of any of the preceding clauses, further comprising securing the at least one forming tool behind the printer head.

Clause 8. The method of any of the preceding clauses, further comprising securing the printer head at a center of the at least one forming tool.

Clause 9. The method of Clause 2, wherein the at least one forming tool comprises the mold, the method further comprising:

extruding the bead of material from the printer head directly into the mold; and

pressing the mold onto the substrate so as to form the article, the mold comprising at least one deformable surface.

Clause 10. The method of Clause 9, further comprising:

pressing the mold onto the substrate before the bead of material is extruded into the mold of the article; and

extruding, via the printer head, the bead of material into an inlet of the mold while the mold is pressed to the substrate.

Clause 11. The method of any of the preceding clauses, further comprising holding the at least one forming tool pressed to the substrate until the bead of material solidifies and bonds to the substrate.

Clause 12. The method of any of the preceding clauses, further comprising heating the at least one forming tool to control a melt rate of the material.

Clause 13. The method of any of the preceding clauses, further comprising cooling the at least one forming tool so as to partially cool the material deposited therein such that the material holds its shape.

Clause 14. The method of any of the preceding clauses, wherein the bead of material comprises at least one of a thermoplastic material, a thermoset material, a metal material, or a concrete material.

Clause 15. The method of any of the preceding clauses, wherein the article comprises a rotor blade component of a wind turbine.

Clause 16. A system for forming an article, comprising:

a substrate;

a print head assembly comprising a printer head mounted above the substrate, the printer head configured for extruding a bead of material; and

at least one forming tool for forming the bead of material to a predefined shape and/or height of the article as the bead of material is being extruded so as to increase a height of the bead of material via the at least one forming tool, thereby reducing or eliminating a number of extruded layers of the material.

Clause 17. The system of Clause 16, wherein the at least one forming tool comprises a die, a mold, or a rolling element.

Clause 18. The system of Clauses 16-17, wherein the at least one forming tool comprises a rolling element secured to the printer head of the print head assembly defining an annular cavity configured for receiving and building up the bead of the material as the bead of material is extruded therein.

Clause 19. The system of Clauses 16-18, wherein the at least one forming tool comprises at least one deformable surface that conforms to the substrate as the at least one forming tool is moved along the substrate.

Clause 20. A method for forming a plurality of articles, the method comprising:

(a) providing a forming tool of one of the plurality of articles having a predefined shape and/or height;

(b) extruding a bead of material from a print head assembly and into the forming tool;

(c) allowing the material to at least partially cool in the forming tool so as to hold its shape and to form one of the plurality of articles;

(d) moving the forming tool along the substrate as the article is released from the forming tool;

(e) repeating steps (a) through (d) to form the plurality of articles;

(f) providing a deformable component at an intersection point between the plurality of articles;

(g) heating the deformable component at the intersection point so as to melt the material at the intersection point; and,

(h) adding additional material at the intersection point so as to join the plurality of articles together.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for forming an article, comprising:
placing at least one forming tool of the article adjacent to a substrate, the at least one forming tool having a predefined shape and/or height;
extruding a bead of material from a printer head of a print head assembly directly into or onto the at least one forming tool of the article so as to increase a height of the bead of material via the at least one forming tool, thereby reducing or eliminating a number of extruded layers of the material; and,
allowing the material to solidify to form the article.

2. The method of claim 1, wherein the at least one forming tool comprises a die, a mold, or a rolling element.

3. The method of claim 2, wherein the at least one forming tool comprises the rolling element, the method further comprising:
securing the rolling element to the printer head of the print head assembly;
extruding the bead of material from the printer head ahead of or directly into a cavity defined by a cross-sectional shape of the rolling element; and
rolling the rolling element along the substrate such that the height of the bead of the material is increased so as to form the article on the substrate.

4. The method of claim 1, further comprising moving the at least one forming tool along the substrate at a predetermined speed as the bead of material is being deposited therein, the predetermined speed and a length of the at least one forming tool being selected to ensure the bead of material has sufficiently solidified before the bead of material exits the at least one forming tool.

5. The method of claim 4, wherein at least a portion of the at least one forming tool is deformable so as to conform to a profile of the substrate as the at least one forming tool is moved along the substrate, the method further comprising moving the at least one forming tool directly on the substrate.

6. The method of claim 1, wherein at least a portion of the at least one forming tool is rigid, the method further comprising holding the at least one forming tool above and spaced apart from the substrate via a gap as the at least one forming tool is moved along the substrate, wherein the gap allows for squeeze out of the material to increase a bond area between the at least one forming tool and the substrate.

7. The method of claim 1, further comprising securing the at least one forming tool behind the printer head.

8. The method of claim 1, further comprising securing the printer head at a center of the at least one forming tool.

9. The method of claim 2, wherein the at least one forming tool comprises the mold, the method further comprising:
extruding the bead of material from the printer head directly into the mold; and
pressing the mold onto the substrate so as to form the article, the mold comprising at least one deformable surface.

10. The method of claim 9, further comprising:
pressing the mold onto the substrate before the bead of material is extruded into the mold of the article; and
extruding, via the printer head, the bead of material into an inlet of the mold while the mold is pressed to the substrate.

11. The method of claim 1, further comprising holding the at least one forming tool pressed to the substrate until the bead of material solidifies and bonds to the substrate.

12. The method of claim 1, further comprising heating the at least one forming tool to control a melt rate of the material.

13. The method of claim 1, further comprising cooling the at least one forming tool so as to partially cool the material deposited therein such that the material holds its shape.

14. The method of claim 1, wherein the bead of material comprises at least one of a thermoplastic material, a thermoset material, a metal material, or a concrete material.

15. The method of claim 1, wherein the article comprises a rotor blade component of a wind turbine.

16. A system for forming an article, comprising:
a substrate;
a print head assembly comprising a printer head mounted above the substrate, the printer head configured for extruding a bead of material; and
at least one forming tool for forming the bead of material to a predefined shape and/or height of the article as the bead of material is being extruded so as to increase a height of the bead of material via the at least one forming tool, thereby reducing or eliminating a number of extruded layers of the material.

17. The system of claim 16, wherein the at least one forming tool comprises a die, a mold, or a rolling element.

18. The system of claim 16, wherein the at least one forming tool comprises a rolling element secured to the printer head of the print head assembly defining an annular cavity configured for receiving and building up the bead of the material as the bead of material is extruded therein.

19. The system of claim 16, wherein the at least one forming tool comprises at least one deformable surface that conforms to the substrate as the at least one forming tool is moved along the substrate.

20. A method for forming a plurality of articles, the method comprising:
(a) providing a forming tool of one of the plurality of articles having a predefined shape and/or height;
(b) extruding a bead of material from a print head assembly and into the forming tool;
(c) allowing the material to at least partially cool in the forming tool so as to hold its shape and to form one of the plurality of articles;
(d) moving the forming tool along the substrate as the article is released from the forming tool;
(e) repeating steps (a) through (d) to form the plurality of articles;
(f) providing a deformable component at an intersection point between the plurality of articles;
(g) heating the deformable component at the intersection point so as to melt the material at the intersection point; and,
(h) adding additional material at the intersection point so as to join the plurality of articles together.
